(19) United States
(12) Patent Application Publication
(10) Pub. No.: US 2026/0237322 A1
(43) Pub. Date: Aug. 13, 2026

(54) INFORMATION PRESENTATION DEVICE, INFORMATION PRESENTATION METHOD, AND INFORMATION PRESENTATION PROGRAM

(71) Applicant: NTT, Inc., Tokyo (JP)

(72) Inventors: Takeru ISAKA, Musashino-shi, Tokyo (JP); Yoko TOKUNAGA, Musashino-shi, Tokyo (JP); Iwaki TOSHIMA, Musashino-shi, Tokyo (JP); Takao NAKAMURA, Musashino-shi, Tokyo (JP)

(73) Assignee: NTT, Inc., Tokyo (JP)

(21) Appl. No.: 19/148,010

(22) PCT Filed: Jan. 17, 2023
(86) PCT No.: PCT/JP2023/001229

§ 371 Date: Jul. 15, 2025

(51) Int. Cl. G09B 19/22; A63F 3/02

(52) U.S. Cl. CPC G09B 19/22; A63F 3/02

(57) ABSTRACT

An information presentation device includes a memory and processing circuitry configured to create an estimator that estimates sensibility information from information specifying an action based on sensibility information felt by an evaluator and information specifying an action corresponding to the sensibility information for each of a series of actions performed by a human, and calculate a degree of agreement between each piece of the sensibility information obtained by inputting information specifying a plurality of actions into the estimator and each piece of the sensibility information associated in advance with the plurality of actions as a level of understanding, extract actions whose level of understanding satisfies a condition from among the plurality of actions, and present information on the extracted actions.

### TECHNICAL FIELD

The present invention relates to an information presentation device, an information presentation method, and an information presentation program.

### BACKGROUND ART

Japanese chess, a type of board game, is known. Beginners in Japanese chess can improve their skills by memorizing the roles of the pieces and repeatedly practicing the standard moves. On the other hand, it is difficult to further enhance the skills of professional players, who already possess the highest level of skill among humans. Professional Japanese chess players are taught how to win from an early age, so their skills are already mature, and they have limited room for growth. The skill of professional players tends to reach a plateau at a certain age after they are promoted to professional status.

The primary method for professional players to learn Japanese chess is by discovering and learning strong moves and strong flows from a vast amount of past game results (game records). In addition to Japanese chess played by humans, the game records also include Japanese chess played by AI, which has recently boasted superior skills to humans. Studies of such game records suggest that players will be able to learn moves that they can understand, that is, moves played by players of the same rank or slightly higher than themselves. On the other hand, to become stronger, professional players must understand the mechanisms of strong moves played by others with higher skills than themselves and be able to use them in actual games. However, there is a problem in that it is difficult to understand and retain game records played by others with higher skills than oneself.

Traditionally, learning methods have been proposed to improve Japanese chess skills. For example, NPL 1 describes a learning support system that allows learners to improve their skills independently by presenting board states that are likely to be formed two moves or more ahead rather than providing direct hints about the board state during a game.

### CITATION LIST

### Non Patent Literature

[NPL 1] Takeshi Ito: Game Learning Support System based on Future Position, ICGA Journal, vol. 40, no. 4, pp. 450-459 (2018).

### SUMMARY OF INVENTION

### Technical Problem

However, the conventional technology has a problem that it may be difficult to learn the sensibility of an expert regarding actions.

For example, the technology described in NPL 1 only presents the board state, and cannot convey the sensibility of an expert regarding the board state to the learner. As a result, the learner cannot learn what sensibility is the basis for selecting a move.

### Solution to Problem

In order to solve the above problem and achieve the object, an information presentation device includes: a creation unit that creates an estimator that estimates sensibility information from information specifying an action based on sensibility information felt by an evaluator and information specifying an action corresponding to the sensibility information for each of a series of actions performed by a human; and a presentation unit that calculates a degree of agreement between each piece of the sensibility information obtained by inputting information specifying a plurality of actions into the estimator and each piece of the sensibility information associated in advance with the plurality of actions as a level of understanding, extracts actions whose level of understanding satisfies a condition from among the plurality of actions, and presents information on the extracted actions.

### Advantageous Effects of Invention

According to the present invention, it is possible to learn the sensibilities of an expert regarding actions.

### BRIEF DESCRIPTION OF DRAWINGS

FIG. 1 is a diagram explaining an information presentation device and an evaluator.

FIG. 2 is a diagram explaining an information presentation device and an evaluator.

FIG. 3 is a diagram explaining an information presentation device and an evaluator.

FIG. 4 is a diagram for explaining an example of the configuration of an information presentation device according to a first embodiment.

FIG. 5 is a diagram illustrating an example of an input screen.

FIG. 6 is a diagram illustrating an example of a sensibility information DB.

FIG. 7 is an example of a graph plotting values in the “pleasant-unpleasant” column.

FIG. 8 is an example of a graph plotting values in the “intense-calm” column.

FIG. 9 is an example of a graph plotting values in the “situation” column.

FIG. 10 is a flowchart for explaining the processing flow of the information presentation device according to the first embodiment.

FIG. 11 is a diagram illustrating an example of a computer that executes the information presentation program.

### DESCRIPTION OF EMBODIMENTS

Below, embodiments of the information presentation device, information presentation method, and information presentation program according to the present application will be described in detail with reference to the drawings. Note that the present invention is not limited to the embodiments described below.

### First Embodiment

The information presentation device of the first embodiment supports a learner in learning the way an expert thinks and feels when performing a series of actions.

In the series of actions, a strategy is determined for each action.

The series of actions is, for example, a board game in which two players alternately place pieces and play against each other. In the present embodiment, the series of actions is assumed to be Japanese chess. The series of actions may also be another board game such as chess. In this way, the information presentation device 10 can support the learning of board games such as Japanese chess.

The information presentation device of the present embodiment acquires the degree of emotion of an evaluator who evaluates a series of actions. The evaluator may be the subject of the series of actions (for example, a player of a board game or the like) or may be an observer of the series of actions.

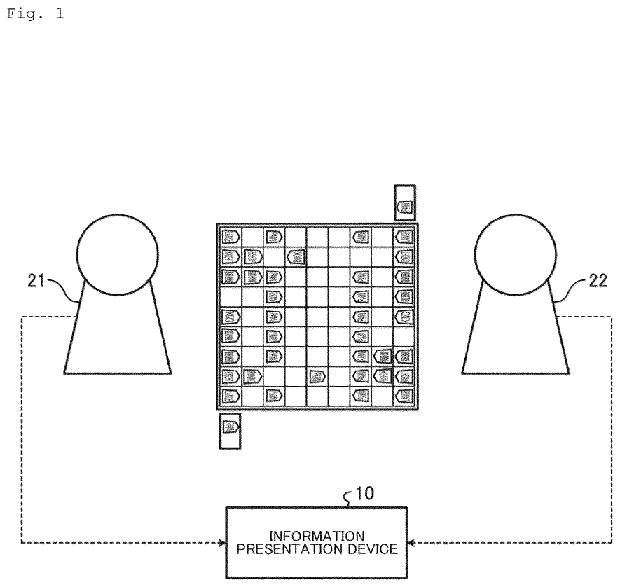

The information presentation device and the evaluator will be described below with reference to FIGS. 1, 2, and 3. FIGS. 1, 2, and 3 are diagrams for explaining the information presentation device and the evaluator.

As illustrated in FIG. 1, an evaluator 21 and an evaluator 22 play Japanese chess. The evaluator 21 and the evaluator 22 are opponents in the game of Japanese chess. In the example of FIG. 1, both the evaluator 21 and the evaluator 22 are the subjects of a series of actions.

The information presentation device 10 acquires the degrees of emotion of the evaluator 21 and the evaluator 22. Details of how the information presentation device 10 acquires the degree of emotion will be described later.

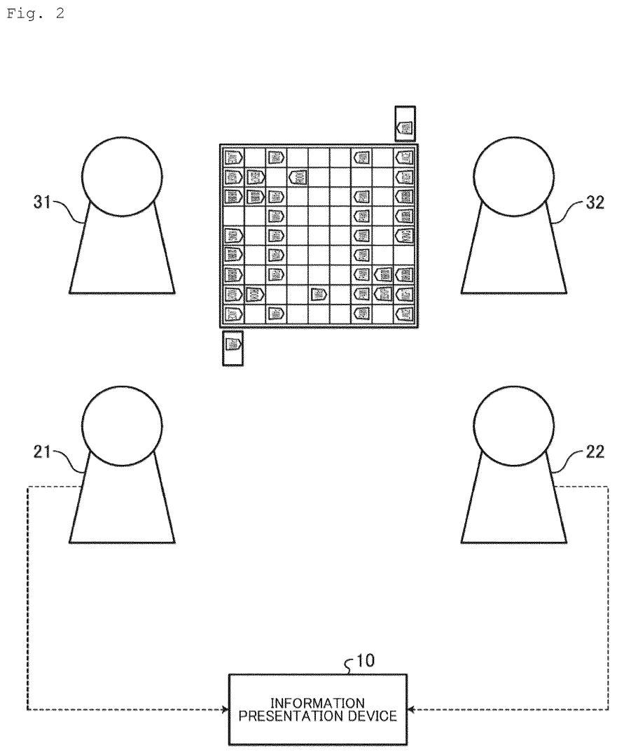

As illustrated in FIG. 2, the evaluator 21 and the evaluator 22 watch the game of Japanese chess played by a player 31 and a player 32. In the example of FIG. 2, both the evaluator 21 and the evaluator 22 are observers of a series of actions. In the following description, the evaluator 21 and the evaluator 22 may be simply referred to as an evaluator without distinction.

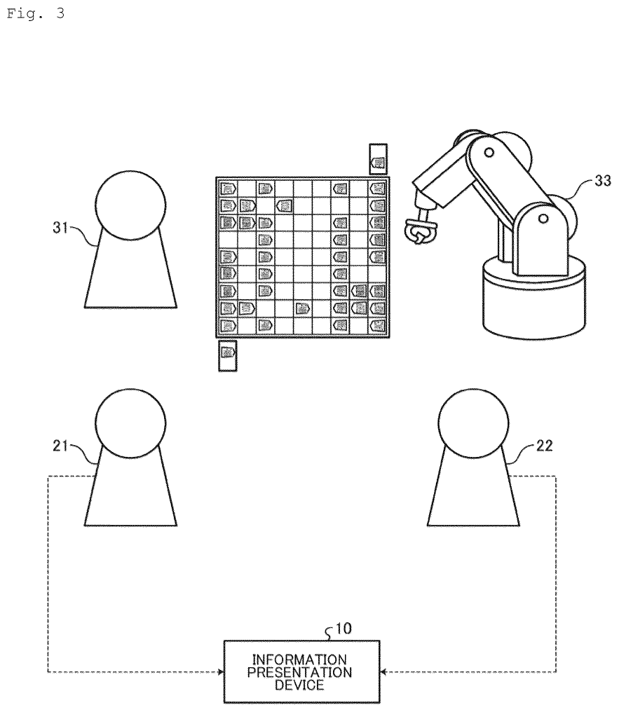

As illustrated in FIG. 3, one (or both) of the Japanese chess players may be a robot. The robot 33 plays Japanese chess according to the judgment of a program (such as a so-called Japanese chess AI). Note that the player may be a human who operates the pieces according to the AI instructions.

### Configuration of First Embodiment

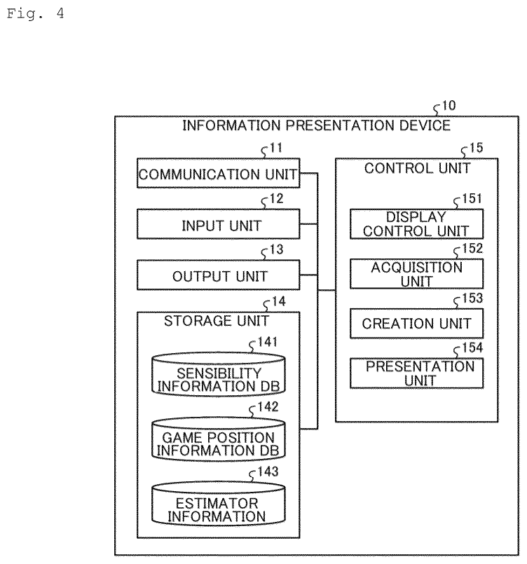

The configuration of the information presentation device according to the first embodiment will be described with reference to FIG. 4. FIG. 4 is a diagram illustrating an example of the configuration of the information presentation device according to the first embodiment.

As illustrated in FIG. 4, the information presentation device 10 has a communication unit 11, an input unit 12, an output unit 13, a storage unit 14, and a control unit 15.

The communication unit 11 performs data communication with other devices via a network. The communication unit 11 is, for example, a network interface card (NIC). The input unit 12 accepts data input from a user. The input unit 12 is connected to an input device such as a mouse and a keyboard. The output unit 13 outputs data by displaying a screen or the like. The output unit 13 is, for example, a display device such as a display.

The storage unit 14 is a storage device, such as a hard disk drive (HDD), a solid state drive (SSD), or an optical disc. The storage unit 14 may be a semiconductor memory capable of rewriting data, such as a random access memory (RAM), a flash memory, and a nonvolatile static random access memory (NVSRAM). The storage unit 14 stores an operating system (OS) and various programs executed by the information presentation device 10.

The storage unit 14 stores a sensibility information DB 141, a game position information DB 142, and estimator information 143. The sensibility information DB 141 includes the degree of emotion or the like input by the evaluator. The game position information DB 142 is information on each game position of Japanese chess, for example, information indicating the placement of pieces. The game position information DB 142 may be an image of the game board at each game position. The estimator information 143 is information on an estimator for outputting (estimating) sensibility information from information on a game position of Japanese chess. The estimator information 143 includes parameters for constructing the estimator.

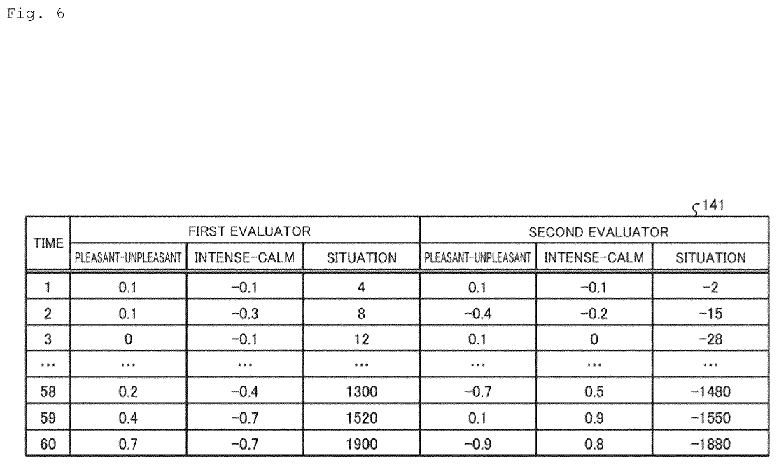

FIG. 6 is a diagram illustrating an example of the sensibility information DB. As illustrated in FIG. 6, the sensibility information DB 141 is a table. The sensibility information DB 141 has a “time” column. The sensibility information DB 141 also has a “pleasant-unpleasant” column, an “intense-calm” column, and a “situation” column for each of the first and second evaluators. The values of each column will be described in detail later.

The control unit 15 controls the entire information presentation device 10. The control unit 15 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA). The control unit 15 includes an internal memory that stores a program defining various types of processing procedures and control data, and executes each step of processing using the internal memory. Also, the control unit 15 functions as various processing units as a result of various programs operating. For example, the control unit 15 has a display control unit 151, an acquisition unit 152, a creation unit 153, and a presentation unit 154.

The display control unit 151 generates a screen. The display control unit 151 displays the generated screen on a display device such as a display via the output unit 13.

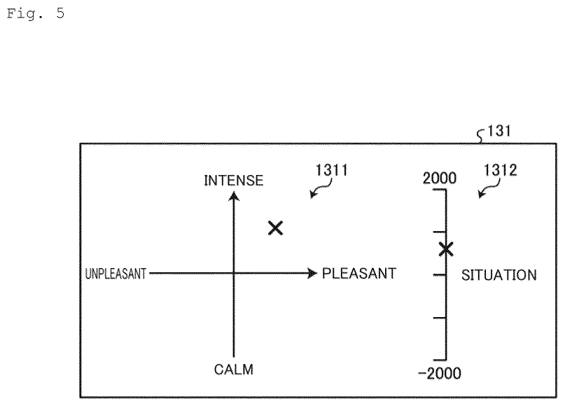

The display control unit 151 generates an input screen for the evaluator to input the degree of emotion or the like. The input screen will be described with reference to FIG. 5. FIG. 5 is a diagram illustrating an example of an input screen.

As illustrated in FIG. 5, the display control unit 151 displays a plot area 1311 for inputting the degree of emotion and a plot area 1312 for inputting the situation on the input screen 131.

The plot area 1311 is a coordinate plane including a vertical axis and a horizontal axis. The vertical axis corresponds to the degree of momentum (intensity or calmness) felt by the evaluator with respect to the move made by the player. The horizontal axis corresponds to the degree of pleasantness felt by the evaluator with respect to the move made by the player. Note that a move is, for example, the act of moving a piece in Japanese chess.

The plot area 1312 is a line with a scale indicating the situation in a Japanese chess match. The evaluator, based on his/her subjective judgment, gives a higher value to the situation the greater an advantage one player has. Conversely, the evaluator, based on his/her subjective judgment, gives a lower value to the situation the greater a disadvantage one player has.

The evaluator plots on the coordinate plane of the plot area 1311 and on the line of the plot area 1312. For example, the evaluator can plot by clicking a mouse, tapping a touch panel, or the like.

For example, if the evaluator feels that the player's move is intense and pleasant, the evaluator plots in the first quadrant of the coordinate plane of the plot area 1311. Also, for example, if the evaluator feels that a predetermined player is dominant, the evaluator plots the position above the center of the line in the plot area 1312.

The range of the vertical and horizontal axes of the coordinate plane of the plot area 1311 is, for example, from −1 to 1. The range of the situation is, for example, from −2000 to 2000 (based on the general evaluation of Japanese chess software).

In the present embodiment, the information presentation device 10 obtains the degree of momentum, the degree of pleasantness, and the situation as the evaluator's sensibility information. The combination of this sensibility information is an example of a combination that is considered to be effective for learning Japanese chess based on interviews with professional Japanese chess players and knowledge of psychology. The sensibility information obtained by the information presentation device 10 is not limited to that described herein.

The range of each index may be determined by the following calibration. That is, first, the evaluator is presented with game positions in which one player has a decisive advantage or disadvantage or is intense or calm in Japanese chess. Then, the evaluator's sensibility information (degree of momentum, degree of pleasantness, and situation) for the presented game positions is acquired. The acquired sensibility information is set to the maximum or minimum value of each piece of sensibility information (degree of momentum, degree of pleasantness, and situation). For example, the degree of momentum felt by the evaluator for a decisively intense game position is set to the maximum degree of momentum.

The game positions presented to the evaluator may be changed according to the evaluator's playing style or the like. For example, if the evaluator's playing style as a player is what is called a “swinging rook player,” it is conceivable that the evaluator will be presented with game positions that are decisively pleasant or unpleasant for a player whose playing style is a “swinging rook player.” Such game positions may not be particularly pleasant or unpleasant for a player whose playing style is not a “swinging rook player.”

The information presentation device 10 may normalize the sensibility information input to the input screen 131 based on the maximum and minimum values obtained by the above method.

The display control unit 151 stores the sensibility information input to the input screen 131 in the sensibility information DB 141. The process of accepting input from the evaluators and storing the sensibility information in the sensibility information DB 141 may be called annotation.

As illustrated in FIGS. 1, 2, and 3, two evaluators each make input to the input screen 131. The evaluator 21 is the first evaluator. The evaluator 22 is the second evaluator.

The display control unit 151 stores values in the “pleasant-unpleasant” column (range: −1 to 1), the “intense-calm” column (range: −1 to 1), and the “situation” column (range: −2000 to 2000) of the first evaluator in the sensibility information DB 141 based on the coordinates of the points plotted by the evaluator 21 on the coordinate plane of the plot area 1311 and the positions of the points plotted on the line of the plot area 1312.

The display control unit 151 stores values in the “pleasant-unpleasant” column, the “intense-calm” column, and the “situation” column of the first evaluator in the sensibility information DB 141 based on the coordinates of the points plotted by the evaluator 21 on the coordinate plane of the plot area 1311 and the positions of the points plotted on the line of the plot area 1312. The “time” column of the sensibility information DB 141 indicates the number of moves in the corresponding game position.

In the example of FIG. 6, the sensibility information DB 141 shows that the degree of pleasantness felt by the first evaluator for the first move was “0.1” (slightly pleasant), the degree of intensity was “−0.1” (slightly calm), and the situation was “4” (slightly advantageous).

In addition, in the example of FIG. 6, the sensibility information DB 141 shows that the degree of pleasantness felt by second evaluator for the first move was “0.1” (slightly pleasant), the degree of intensity was “−0.1” (slightly calm), and the situation was “−2” (slightly disadvantageous).

In the example of FIG. 6, the sensibility information DB 141 indicates that the degree of pleasantness felt by the first evaluator for the 60th move was “0.7” (very pleasant), the degree of intensity was “−0.7” (very calm), and the situation was “1900” (very advantageous).

In the example of FIG. 6, the sensibility information DB 141 indicates that the degree of pleasantness felt by the second evaluator for the 60th move was “−0.9” (very unpleasant), the degree of intensity was “0.8” (very intense), and the situation was “−1880” (very disadvantageous).

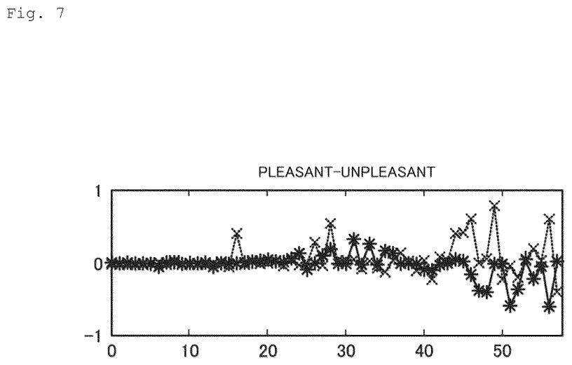

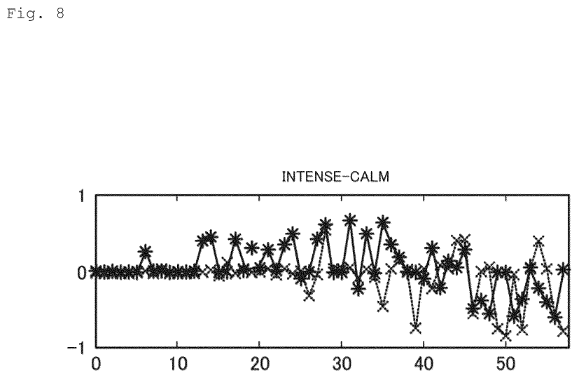

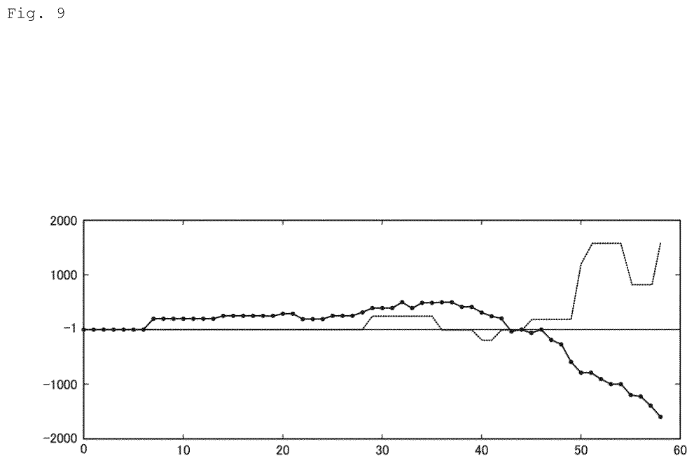

As illustrated in FIG. 7, FIG. 8, and FIG. 9, the difference in each piece of emotion information between evaluators changes for each move. FIG. 7 is an example of a graph plotting values in the “pleasant-unpleasant” column. FIG. 8 is an example of a graph plotting values in the “intense-calm” column. FIG. 9 is an example of a graph plotting values in the “situation” column.

The dashed line in FIG. 7 indicates the degree of pleasantness for each move of the first evaluator. The solid line in FIG. 7 indicates the degree of pleasantness for each move of the second evaluator. The dashed line in FIG. 8 indicates the degree of intensity for each move of the first evaluator. The solid line in FIG. 8 indicates the degree of intensity for each move of the second evaluator. The dashed line in FIG. 9 indicates the situation for each move of the first evaluator. The solid line in FIG. 9 indicates the degree of situation for each move of the second evaluator.

The acquisition unit 152 acquires the sensibility information felt by the evaluator for each of a series of actions performed by a human.

That is, the acquisition unit 152 acquires the sensibility information of each evaluator for each move of a Japanese chess game from the sensibility information DB 141. For example, the value of the “situation” column of the evaluator corresponding to the learner among the first evaluator and the second evaluator is acquired as emotion information.

The creation unit 153 creates an estimator that estimates sensibility information from the information specifying the action based on the sensibility information acquired by the acquisition unit 152 and the information specifying the action corresponding to the sensibility information.

The information specifying the action is information on the game position in Japanese chess. Furthermore, a game position in Japanese chess is expressed by the placement of pieces for each move. The creation unit 153 therefore creates an estimator that estimates information indicating the situation from the placement of pieces. The creation unit 153 can also acquire the placement of pieces for each move from the game position information DB 142.

The estimator is, for example, a machine learning model such as a neural network. The creation unit 153 trains the estimator using a machine learning technique.

The creation unit 153 inputs game position information acquired from the game position information DB 142 to an untrained estimator. The game position information includes pieces placed by a move and their positions, whether the move is first or second, and the game position after the move (placement of pieces on the board). The game position information is quantified in a format such as a vector that can be input to the estimator. The creation unit 153 may also input an evaluation value of the formation of the game position determined by the AI as auxiliary information.

Then, the creation unit 153 updates the parameters of the estimator so that the output of the estimator approaches the sensibility information of the evaluator as a learner, corresponding to the input game position information of the learner. In other words, the sensibility information of the evaluator as the learner is the correct answer data.

The creation unit 153 repeats the above process once or a plurality of times to make the output of the estimator conform to the tendency of the sensibility information of the learner. The creation unit 153 also stores the updated parameters in the storage unit 14 as the estimator information 143.

The presentation unit 154 calculates the degree of agreement between each of the sensibility information obtained by inputting information specifying a plurality of actions into the estimator and each of the sensibility information associated in advance with the plurality of actions as the level of understanding, extracts actions whose level of understanding satisfies a condition from among the plurality of actions, and presents information on the extracted actions.

First, the presentation unit 154 lists candidates for the next development, including the next move in a certain game position of Japanese chess. For example, the presentation unit 154 uses the AI or the like of Japanese chess software to list development candidates. The development candidates are expressed in the same format as the game position information input to the estimator.

The presentation unit 154 inputs each of the development candidates to a previously created estimator and outputs sensibility information corresponding to each candidate.

Furthermore, the presentation unit 154 calculates emotion information for each of the listed candidates. For example, the presentation unit 154 calculates the situation for each of the listed candidates using the AI of Japanese chess software.

The presentation unit 154 calculates the learner's level of understanding of the situation as follows:
Level of understanding=(Situation output by estimator)/(situation calculated using AI of Japanese chess software)

The greater the degree of agreement between the situation output by the estimator and the situation calculated using the AI of Japanese chess software, the closer the level of understanding is to 1. The closer the level of understanding is to 1, the closer the situation, which is the learner's sensibility information, is to the situation calculated using the AI of the Japanese chess software.

The presentation unit 154 presents as an output the level of understanding for each development and the moves included therein. Note that, instead of the situation output by the estimator, the evaluator's emotion information obtained by annotation may be used to calculate the level of understanding.

By simulating developments using the AI of a huge number of Japanese chess software products, a huge number of candidates for game positions can be obtained. The presentation unit 154 calculates the level of understanding for each of the obtained candidates, extracts actions whose level of understanding satisfies the conditions, and presents the placement of pieces, the level of understanding, and the like for the extracted candidates.

In addition, even if the level of understanding of a previous game position among consecutive game positions is high, the level of understanding before that game position may be low. The presentation unit 154 presents information on a game position where the level of understanding is less than a threshold (for example, one move ahead of the current game position) if the level of understanding of the next game position (for example, three moves ahead of the current game position) is equal to or greater than the threshold. This allows the evaluator to learn moves that are difficult for the evaluator to think of and that lead to a move that the evaluator prefers.

### Processing Flow of First Embodiment

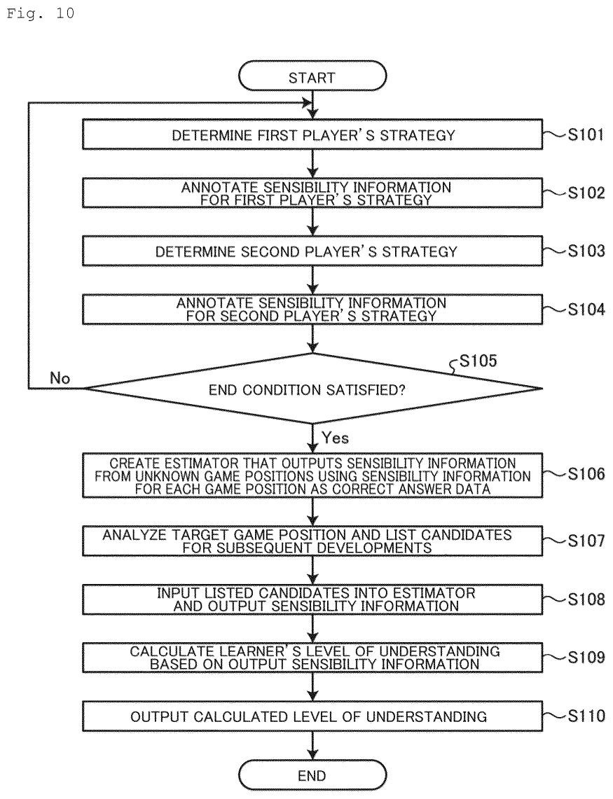

The processing flow of the information presentation device 10 will be described with reference to FIG. 10. FIG. 10 is a flowchart diagram for explaining the processing flow of the information presentation device of the first embodiment.

Here, it is assumed that two players are playing Japanese chess as before. It is also assumed that one of the players is the first player and the other is the second player. The evaluators may be players or observers.

It is also assumed that among the evaluators, the first evaluator is on the side of the first player, and the second evaluator is on the side of the second player. In other words, the first evaluator considers the situation value to be higher the greater an advantage the first player has, and feels positive emotions such as happiness and joy when the first player wins. Conversely, the first evaluator considers the situation value to be lower the greater a disadvantage the first player has, and feels negative emotions such as sadness and displeasure when the first player loses.

As illustrated in FIG. 10, first, the strategy of the first player is determined (step S101). That is, the first player changes the placement of the pieces.

The information presentation device 10 then annotates the first player's strategy with sensibility information (step S102). That is, the information presentation device 10 accepts input of emotion information from the first and second evaluators for the first player's strategy, and stores the input emotion information together with the game position information.

Next, the second player's strategy is determined (step S103). That is, the second player changes the placement of the pieces.

The information presentation device 10 then annotates the second player's strategy with sensibility information (step S104). That is, the information presentation device 10 accepts input of emotion information from the first and second evaluators for the second player's strategy, and stores the input emotion information together with the game position information.

The information presentation device 10 repeats the processing from step S101 to step S104 until the end condition is satisfied (step S105, No).

When the end condition is satisfied (step S105, Yes), the information presentation device 10 creates an estimator that outputs sensibility information from an unknown game position using the sensibility information of one of the evaluators (corresponding to learners) for each game position as teacher data (step S106).

The information presentation device 10 analyzes the target game position and lists candidates for the subsequent development (step S107). For example, the information presentation device 10 uses the AI of Japanese chess software to list the moves and game positions following the target game position as candidates.

The information presentation device 10 inputs the listed moves to an estimator and outputs sensibility information (step S108). The information presentation device 10 calculates the learner's level of understanding based on the output sensibility information (step S109) and outputs the calculated level of understanding (step S110).

### Effects of First Embodiment

As described above, the information presentation device 10 has the creation unit 153 and the presentation unit 154. The creation unit 153 creates an estimator that estimates sensibility information from information specifying an action based on sensibility information felt by the evaluator and information specifying an action corresponding to the sensibility information for each of a series of actions performed by a human. The presentation unit 154 calculates the degree of agreement between each piece of sensibility information obtained by inputting information specifying a plurality of actions into the estimator and each piece of the sensibility information associated in advance with the plurality of actions as the level of understanding, extracts actions whose level of understanding satisfies a condition from among the plurality of actions, and presents information on the extracted actions.

The learner performs studies such as pursuing a strong move for the game position while referring to the output of the estimator or the level of understanding presented by the presentation unit 154. The learner may study alone or in groups. The learner may also refer to game record information and the like together with the output of the estimator or the level of understanding presented by the presentation unit 154.

Example: For a move that the learner has given up understanding after seeing only one move, by referring to the output of a development recommendation unit, the learner can now reconsider the move as an exquisite move, knowing that several moves ahead, it will lead to a position that the learner favors. As a presentation method, it is possible to graphically display a move with a low level of understanding followed by a move with a high level of understanding on the Japanese chess software based on the output of the development recommendation unit.

When studying strong moves for a certain game position, even if a learner discovers and selects a move that the learner already understands, it does not provide new knowledge or lead to improvement in skills. To improve skills, it is important to discover and understand moves that the learners do not understand or have overlooked.

By using the pre-created estimator, it is possible to estimate the learner's sensibility information for a plurality of unknown game positions. This allows the learner to easily find a development in which the learner has a low level of understanding of the next move he or she will make in his/her position (first or second player), and the subsequent developments include many moves that the learner has a high level of understanding. In such a development, the most recent move is difficult, but the subsequent developments are likely to be easier for the learner to understand. If the learner concentrates on only the most recent move and deepens their understanding, the learner will be able to use strong new moves and developments (the length of which changes depending on the difficult section).

In other words, according to the present embodiment, it is possible to present moves that improve the learner's skill and are easy to understand among a vast number of developments presented by the AI of the Japanese chess software. A learner can select and study only those developments that are most effective for learning from among the vast number of developments for a game position.

### Effects in General Goal Achievement Outside Field of Japanese Chess

The present embodiment is applicable to fields other than Japanese chess. When a person acts toward a goal, there are numerous processes that lead to its achievement. If one simply relies on trial and error, it is difficult to achieve the goal in situations where there are many walls of difficulty in the process. The learner may become exhausted and give up on achieving the goal.

Therefore, the information presentation device 10 presents the actions included in the plurality of processes leading to the goal along with the learner's level of understanding, so that the learner can select a process that is easy to achieve and surely brings the learner closer to achieving the goal.

### Example of Effects in Agricultural Field

For rare plants, various growth processes such as the timing and amount of watering, humidity control, and sunlight regulation are intricately intertwined until they achieve optimal growth. In addition, these processes are not manualized, but need to be implemented based on highly accurate observation (sensory understanding) of the plants and the environment. If the goal is to cultivate the world's largest rare plant from scratch, the entire process from start to finish involves highly intricate and delicate adjustments, making it difficult to complete.

Therefore, by utilizing the level of understanding presented by an estimator created based on the learner's sensibility information regarding plant cultivation, it is possible to first focus on adjusting processes that are easy to understand (for example, a grower with high sensibility to the green color of leaves first uses this sensibility to instruct the timing of fertilization as a task that makes it easy to use that sensibility) and recommend a process that starts with achieving small goals, such as extending the number of days until the plant withers, thereby bringing the learner closer to achieving the final goal.

### System Configuration and the Like

In addition, each component of each illustrated device is functionally conceptual, and does not necessarily need to be physically configured as illustrated. That is, a specific form of distribution and integration of devices is not limited to the illustrated form, and all or a part thereof can be functionally or physically distributed or integrated in any unit according to various loads, usage conditions, and the like. Furthermore, all or some of the processing functions performed by each device may be realized by a CPU (Central Processing Unit) and a program that is analyzed and executed by the CPU, or may be realized as hardware using wired logic. The program may be executed not only by the CPU but also by another processor such as a GPU.

In addition, among the processes described in the embodiment, all or some of the processes described as being automatically performed can be manually performed or, alternatively, all or some of the processes described as being manually performed can be automatically performed by known methods. Furthermore, information including processing procedures, control procedures, specific names, various data and parameters having been described above or illustrated in the drawings may be arbitrarily changed unless otherwise described.

### Program

As one embodiment, the information presentation device 10 can be implemented by installing an information presentation program for executing the above information presentation processing on a desired computer as package software or online software. For example, an information processing device can be caused to function as the information presentation device 10, by causing the information processing device to execute the above information presentation program. The information processing device mentioned herein includes a desktop or a laptop personal computer. In addition, the information processing device may also include mobile communication terminals such as smartphones, mobile phones, and personal handyphone systems (PHSs), xR devices such as all-in-one AR glasses and VR goggles, and slate terminals such as personal digital assistants (PDAs) and tablet terminals.

The information presentation device 10 may also be implemented as an information presentation server device that provides services related to the above-mentioned information presentation process to a client, the client being a terminal device used by a user. For example, the information presentation server device is implemented as a server device that provides an information presentation service that receives as input the sensibility information of an evaluator and outputs the sensibility information with a large difference between evaluators and the information of the corresponding game position. In this case, the information presentation server device may be implemented as a Web server, or may be implemented as a cloud that provides services related to the above-mentioned information presentation process by outsourcing.

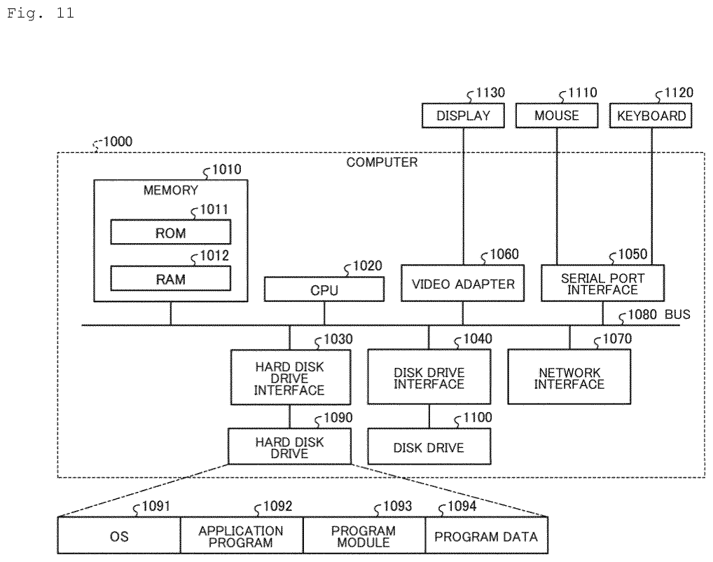

FIG. 11 is a diagram illustrating an example of a computer that executes the information presentation program. A computer 1000 includes, for example, a memory 1010 and a CPU 1020. Further, the computer 1000 also includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each process of the information presentation device 10 is implemented as a program module 1093 in which computer-executable codes are written. The program module 1093 is stored in, for example, the hard disk drive 1090. For example, the program module 1093 for executing a process similar to the functional configuration of the information presentation device 10 is stored in the hard disk drive 1090. The hard disk drive 1090 may be replaced with a solid state drive (SSD).

Furthermore, the setting data used in the processing of the above-described embodiment is stored, for example, in the memory 1010 or the hard disk drive 1090 as the program data 1094. The CPU 1020 reads the program module 1093 or the program data 1094 stored in the memory 1010 or the hard disk drive 1090 into the RAM 1012 as necessary, and executes the processing of the above-described embodiment.

Note that the program module 1093 and the program data 1094 are not limited to being stored in the hard disk drive 1090, and may be stored in, for example, a detachable storage medium and read by the CPU 1020 via the disk drive 1100 or the like.

Alternatively, the program module 1093 and the program data 1094 may be stored in another computer connected via a network (a local area network (LAN), a wide area network (WAN), or the like). Then, the program module 1093 and the program data 1094 may be read by the CPU 1020 from another computer via the network interface 1070.

### Reference Signs List

10 Information presentation device
11 Communication unit
12 Input unit
13 Output unit
14 Storage unit
15 Control unit
141 Sensibility information DB
142 Game position information DB
143 Estimator information
151 Display control unit
152 Acquisition unit
153 Creation unit
154 Presentation unit

1. An information presentation device comprising:
a memory; and
processing circuitry configured to:
create an estimator that estimates sensibility information from information specifying an action based on sensibility information felt by an evaluator and information specifying an action corresponding to the sensibility information for each of a series of actions performed by a human; and
calculate a degree of agreement between each piece of the sensibility information obtained by inputting information specifying a plurality of actions into the estimator and each piece of the sensibility information associated in advance with the plurality of actions as a level of understanding, extract actions whose level of understanding satisfies a condition from among the plurality of actions, and present information on the extracted actions.

2. The information presentation device according to claim 1, wherein the processing circuitry is further configured to create an estimator that estimates information indicating a situation from piece placement in a board game in which two players alternately place pieces and play against each other, based on information indicating the situation in a game felt by the evaluator for each piece placement in the board game by each player.

3. The information presentation device according to claim 2, wherein the processing circuitry is further configured to calculate a degree of agreement between information indicating the situation obtained by inputting the piece placement into the estimator created and information indicating a situation determined in advance for placement as a level of understanding of the evaluator for the placement.

4. An information presentation method executed by an information presentation device, comprising:
acquiring sensibility information felt by an evaluator for each of a series of actions performed by a human; and
creating an estimator that estimates sensibility information from information specifying an action based on the sensibility information acquired and information specifying an action corresponding to the sensibility information.

5. A non-transitory computer-readable recording medium storing therein an information presentation program that causes a computer to execute a process comprising:
acquiring sensibility information felt by an evaluator for each of a series of actions performed by a human; and
creating an estimator that estimates sensibility information from information specifying an action based on the sensibility information acquired and information specifying an action corresponding to the sensibility information.
